(19) United States
(12) Patent Application Publication
(10) Pub. No.: US 2010/0162247 A1
(43) Pub. Date: Jun. 24, 2010

(54) METHODS AND SYSTEMS FOR TRANSACTIONAL NESTED PARALLELISM

(76) Inventors: Adam Welc, San Francisco, CA (US); Haris Volos, Madison, WI (US); Ali Adl-Tabatabai, San Jose, CA (US); Tatiana Shpeisman, Menlo Park, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/340,374

(22) Filed: Dec. 19, 2008

(51) Int. Cl. G06F 9/46

(52) U.S. Cl. 718/101

(57) ABSTRACT

Methods and systems for executing nested concurrent threads of a transaction are presented. In one embodiment, in response to executing a parent transaction, a first group of one or more concurrent threads including a first thread is created. The first thread is associated with a transactional descriptor comprising a pointer to the parent transaction.

### FIELD OF THE INVENTION

Embodiments of the invention relate to execution in computer systems; more particularly, embodiments of the invention relate to transactional memory.

### BACKGROUND OF THE INVENTION

The increasing number of processing cores and logical processors on integrated circuits enables more software threads to be executed. Accesses to shared data need to be synchronized because the software threads may be executed simultaneously. One common solution to accessing shared data in multi-core (or multiple logical processors) system comprises the use of locks to guarantee mutual exclusion across multiple accesses to shared data.

Another data synchronization technique includes the use of transactional memory (TM). Transactional memory simplifies concurrent programming, which has been crucial in realizing the performance benefit of multi-core processors. Transactional memory allows a group of load and store instructions to execute in an atomic way. Transactional memory also alleviates those pitfalls of lock-based synchronization.

Often transactional execution includes speculatively executing groups of a plurality of micro-operations, operations, or instructions. Accesses to shared data object are monitored or tracked. If more than one transaction alters the same entry, one of the transactions may be aborted to resolve the conflict. As such, data isolation of a share data object is enforced among the transactions.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates an embodiment of a system including a processor and a memory capable of transactional execution.

FIG. 2 is shows an exemplary execution of a transactional memory system supporting transactional nested parallelism in accordance with an embodiment of the invention.

FIG. 3 shows a block diagram of an embodiment of a transactional memory system.

FIG. 4 shows a block diagram of an embodiment of a quiescence table and meta-data associated with a shared data object.

FIG. 5 shows an embodiment of a memory device to store a transactional descriptor, an array of meta-data, and a data object.

FIG. 6 is a flow diagram for an embodiment of a process to implement transactional nested parallelism.

FIG. 7 is a block diagram of one embodiment of a transactional memory system.

FIG. 8 illustrates a point-to-point computer system in conjunction with one embodiment of the invention.

### DETAILED DESCRIPTION OF THE INVENTION

Methods and systems for executing nested concurrent threads of a transaction are presented. In one embodiment, in response to executing a parent transaction, a first group of one or more concurrent threads including a first thread is created. The first thread is associated with a transactional descriptor comprising a pointer to the parent transaction.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

The systems described herein are for executing nested concurrent threads of a transaction. Specifically, executing nested concurrent threads of a transaction is primarily discussed in reference to multi-core processor computer systems. However, systems described herein for executing nested concurrent threads of a transaction are not so limited, as they may be implemented on or in association with any integrated circuit device or system, such as cell phones, personal digital assistants, embedded controllers, mobile platforms, desktop platforms, and server platforms, as well as in conjunction with other resources, such as hardware/software threads, that utilize transactional memory.

### Transactional Memory System

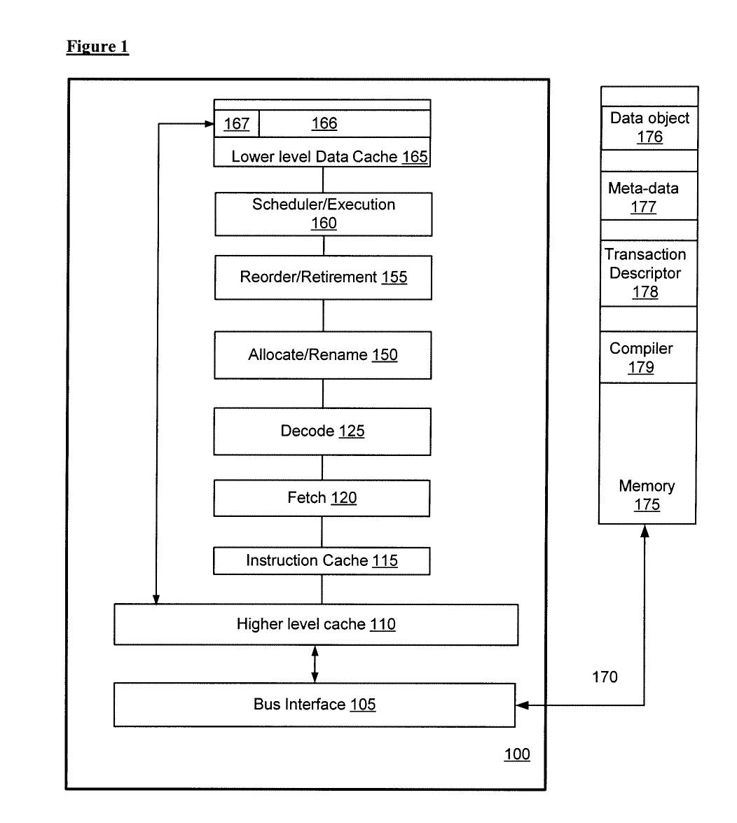

FIG. 1 illustrates an embodiment of a system including a processor and a memory capable of performing transactional execution. Referring to FIG. 1, in one embodiment, processor 100 is a multi-core processor capable of executing multiple threads in parallel. In one embodiment, processor 100 includes any processing element, such as an embedded processor, cell-processor, microprocessor, or other known processor, which is capable of executing one thread or multiple threads.

The modules shown in processor 100, which are discussed in more detail below, are potentially implemented in hardware, software, firmware, or a combination thereof. Note that the illustrated modules are logical blocks, which may overlap the boundaries of other modules, and may be configured or interconnected in any manner. In addition, not all the modules as shown in FIG. 1 are required in processor 100. Furthermore, other modules, units, and known processor features may also be included in processor 100.

In one embodiment, processor 100 comprises lower level data cache 165, scheduler/execution module 160, reorder/retirement module 155, allocate/rename module 150, decode logic 125, fetch logic 120, instruction cache 115, higher level cache 110, and bus interface module 105.

In one embodiment, bus interface module 105 communicates with a device, such as system memory 175, a chipset, a north bridge, an integrated memory controller, or other integrated circuit. In one embodiment, bus interface module 105 includes input/output (I/O) buffers to transmit and to receive bus signals on interconnect 170. Examples of interconnect 170 include a Gunning Transceiver Logic (GTL) bus, a GTL+ bus, a double data rate (DDR) bus, a pumped bus, a differential bus, a cache coherent bus, a point-to-point bus, a multi-drop bus, and other known interconnect implementing any known bus protocol.

In one embodiment, processor 100 is coupled to system memory 175, which may be dedicated to processor 100 or shared with other devices in a system. Examples of memory 175 includes dynamic random access memory (DRAM), static RAM (SRAM), non-volatile memory (NV memory), and long-term storage. In one embodiment, bus interface unit 105 communicates with higher-level cache 110.

In one embodiment, higher-level cache 110 caches recently fetched data. In one embodiment, higher-level cache 110 is a second-level data cache. In one embodiment, instruction cache 115, which is also referred to as a trace cache, is coupled to fetch logic 120. In one embodiment, instruction cache 115 stores recently fetched instructions that have not been decoded. In one embodiment, instruction cache 115 is coupled to decode logic 125 and stores decoded instructions.

In one embodiment, fetch logic 120 fetches data/instructions to be operated on. Although not shown, in one embodiment, fetch logic 120 includes or is associated with branch prediction logic, a branch target buffer, a prefetcher, or the combination thereof to predict branches to be executed. In one embodiment, fetch logic 120 pre-fetches instructions along a predicted branch for execution. In one embodiment, decode logic 125 is coupled to fetch logic 120 to decode fetched elements.

In one embodiment, allocate/rename module 150 includes an allocator to reserve resources, such as register files to store processing results of instructions and a reorder buffer to track instructions. In one embodiment, allocate/rename module 150 includes a register renaming module to rename program reference registers to other registers internal to processor 100.

In one embodiment, reorder/retirement module 125 includes components, such as the reorder buffers mentioned above, to support out-of-order execution and retirement of instructions executed out-of-order. In one embodiment, processor 100 is an in-order execution processor, and reorder/retirement module 155 is not included.

In one embodiment, scheduler/execution module 160 includes a scheduler unit to schedule operations on execution units. Register files associated with execution units are also included to store processing results. Exemplary execution units include a floating point execution unit, an integer execution unit, a jump execution unit, a load execution unit, a store execution unit, and other known execution units.

In one embodiment, data cache 165 is a low level data cache. In one embodiment, data cache 165 is to store recently used elements, such as data operands, objects, units, or items. In one embodiment, a data translation look-aside buffer (DTLB) is associated with lower level data cache 165.

In one embodiment, processor 100 logically views physical memory as a virtual memory space. In one embodiment, processor 100 includes a page table structure to view physical memory as a plurality of virtual pages. A DTLB supports translation of virtual to linear/physical addresses. In one embodiment, data cache 165 is used as a transactional memory or other memory to track memory accesses during execution of a transaction, as discussed in more detail below.

In one embodiment, processor 100 is a multi-core processor. In one embodiment, a core is logic located on an integrated circuit capable of maintaining an independent architectural state, wherein each architectural state is associated with at least some dedicated execution resources. In one embodiment, scheduler/execution module 160 includes physically separate execution units dedicated to each core. In one embodiment, scheduler/execution module 160 includes execution units that are physically arranged as a same unit or units in close proximity, yet, portions of scheduler/execution module 160 are logically dedicated to each core. In one embodiment, each core shares access to processor resources, such as, for example, higher level cache 110.

In one embodiment, processor 100 includes a plurality of hardware threads. A hardware thread is logic located on an integrated circuit capable of maintaining an independent architectural state, wherein the architectural states share access to some execution resources. For example, smaller resources, such as instruction pointers, renaming logic in allocate/rename module 150, an instruction translation look-aside buffer (ITLB) are replicated for each hardware thread. In one embodiment, resources, such as re-order buffers in reorder/retirement module 155, load/store buffers, and queues are shared by hardware threads through partitioning. In one embodiment, other resources, such as lower level data cache 165, scheduler/execution module 160, and parts of reorder/retirement module 155 are fully shared.

As can be seen, as certain processing resources are shared and others are dedicated to an architectural state, the line between the nomenclature of a hardware thread and core overlaps. Yet often, a core and a hardware thread are viewed by an operating system as individual logical processors, with each logical processor being capable of executing a thread. Logical processors, cores, and threads may also be referred to as resources to execute transactions. Therefore, a multi-resource processor, such as processor 100, is capable of executing multiple threads.

In one embodiment, a transaction includes a grouping of instructions, operations, or micro-operations, which may be grouped by hardware, software, firmware, or a combination thereof. For example, instructions may be used to demarcate a transaction. In one embodiment, during execution of a transaction, updates to memory are not made globally visible until the transaction is committed. While the transaction is still pending, locations loaded from and written to within a memory are tracked. Upon successful validation of those memory locations, the transaction is committed and updates made during the transaction are made globally visible. However, if the transaction is invalidated during its pendency, the transaction is restarted without making the updates globally visible. A transaction that has begun execution and has not been committed or aborted is referred to herein as a pending transaction.

In one embodiment, a transaction is a thread executed atomically, and is using shared data protected via data isolation. In one embodiment, a transaction includes a sequence of thread operations executed atomically. Two example systems for transactional execution include a hardware transactional memory (HTM) system and a software transactional memory (STM) system, which are well-known in the art.

In one embodiment, a hardware transactional memory (HTM) system tracks accesses during execution of a transaction with hardware of processor 100. For example, cache line 166 is to store data object 176 in system memory 175. During execution of a transaction, attribute field 167 is used to track accesses to and from cache line 166. For example, attribute field 167 includes a transaction read bit to track whether cache line 166 has been read during execution of a transaction and a transaction write bit to track whether cache line 166 has been written to during execution of the transaction. In one embodiment, data stored in attribute field 167 are used to track accesses and detect conflicts during execution of a transaction, as well as upon attempting to commit the transaction.

In one embodiment, a software transactional memory (STM) system includes performing access tracking, conflict resolution, or other transactional memory tasks in software. In one embodiment, compiler 179 in system memory 175, when executed by processor 100, compiles program code to insert read and write barriers into load and store operations, accordingly, which are part of transactions within the program code. In one embodiment, compiler 179 inserts other transaction related operations, such as initialization, commit or abort operations.

In one embodiment, cache 165 is to cache data object 176, meta-data 177, and transaction descriptor 178. In one embodiment, meta-data 177 is associated with data object 176 to indicate whether data object 176 is locked. In one embodiment, transaction descriptor 178 includes a read log to record read operations. In one embodiment, a write buffer is used to buffer or to log write operations. A transactional memory system uses the logs to detect conflicts and to validate transaction operations. Examples of use for transaction descriptor 178 and meta-data 177 will be discussed in more detail in reference to following Figures.

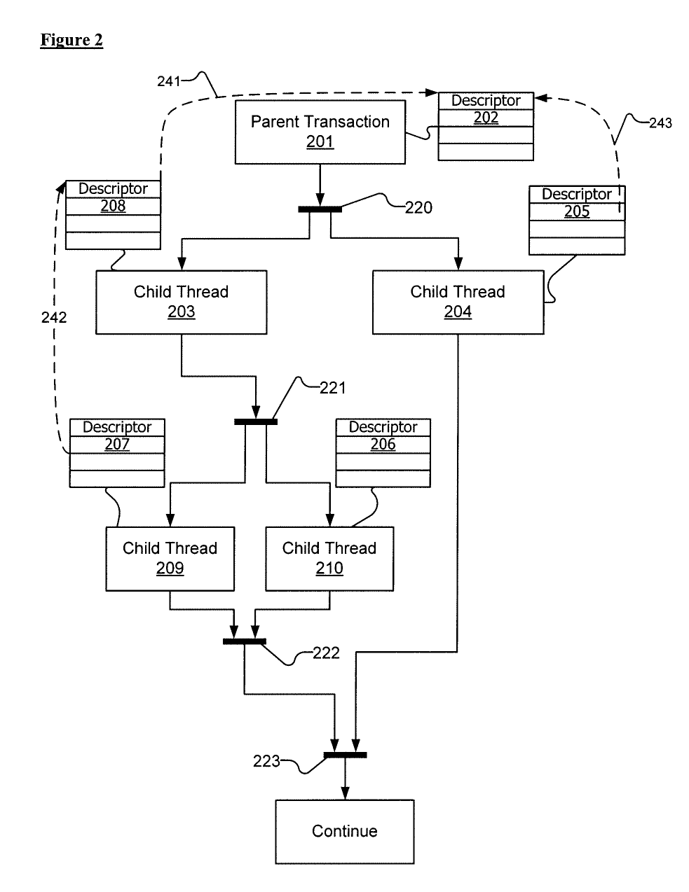

FIG. 2 shows an exemplary execution of a transactional memory system supporting transactional nested parallelism in accordance with an embodiment of the invention. In one embodiment, the execution is performed by processing logic that may comprise hardware (circuitry, dedicated logic, etc.), software (such as is run on a general purpose computer system or a dedicated machine), or a combination of both. In one embodiment, the execution is performed by processor 100 with respect to FIG. 1.

The concept of a thread team (a group of threads) created in a context of a transaction with a purpose of performing some (concurrent) computation on behalf of the transaction is referred to herein as transactional nested parallelism. In one embodiment, a transaction that spawns concurrent threads is referred to herein as a parent transaction.

Many transactional memory systems only implement a single execution thread within a single transaction. In such systems, a transaction is not allowed to call a library function that might spawn multiple threads. Some transactional memory systems disallow concurrent transactions if any of the transactions calls a library function that might spawn multiple threads.

Referring to FIG. 2, in one embodiment, the exemplary execution includes parent transaction 201, child threads (203-204, 209-210), and descriptors (202, 205-208). A thread/transaction is associated with a descriptor, for example, parent transaction 201 is associated with descriptor 202.

In one embodiment, in response to executing parent transaction 201, processing logic creates two child threads (child threads 203-204) at fork point 220. In one embodiment, child threads 203-304 constitute a thread team created to perform some computation on behalf of parent transaction 201. In one embodiment, the concurrent threads spawned by parent transaction 201 are also referred to herein as nested threads. In one embodiment, the concurrent threads spawned within the context of parent transaction 201 conform to atomicity and data isolation as a transaction. A child thread is also referred to herein as a team member.

In one embodiment, processing logic creates child thread 203 and child thread 204 according to a fork-join model, such as a fork-join model in Open Multi-Processing (OpenMP). A group of threads is created by a parent thread (e.g., parent transaction 201 or a master thread) at a fork point (e.g. fork point 220). In one embodiment, processing logic suspends the execution of parent transaction 201 before spawning off child threads 203-204. In one embodiment, processing logic resumes execution of parent transaction 201 after child threads complete their execution.

In one embodiment, child thread 203 further spawns two other child threads (209 and 210) at fork point 221. Child thread 209 and child thread 210 join at join point 222 upon completing the execution. Subsequently, child thread 203 and child thread 204 join at join point 223.

In one embodiment, processing logic resumes parent transaction 201 (from being suspended) at join point 223 after the computation performed by the thread team is completed.

In one embodiment, processing logic executes child thread 203 and child thread 204 atomically, and shared data between the child threads are protected via data isolation if the child threads include nested transactions. In one embodiment, computation by a thread team working on behalf of a transaction is performed atomically and shared data among team members or across multiple thread teams are protected by data isolation if the team members are created as transactions.

In one embodiment, child thread 203 and child thread 204 are threads without nested transactions, and data concurrency between the two threads are not guaranteed. Nevertheless, data concurrency between parent transaction 201 (including execution of threads 203-204) and other transactions are protected.

In one embodiment, child thread 203 and child thread 204 are in a same nesting level because both threads are spawned from a same parent transaction (parent transaction 201). In one embodiment, child thread 209 and child thread 210 are in a same nesting level because both threads are spawned from a same parent thread (child thread 203). In one embodiment, a nesting level is also referred to herein as an atomic block nesting level.

In one embodiment, the descriptor of a child thread includes an indication (e.g., pointers 241-243) to the parent. For example, descriptor 207 associated with child thread 209 includes an indication to descriptor 208 associated with child thread 203 which is the parent thread of child thread 209. Descriptor 205 associated with child thread 204 includes an indication to descriptor 202 associated with parent transaction 201, where parent transaction 201 is the parent thread of child thread 204.

In one embodiment, a transactional memory system supports in-place updates, pessimistic writes, and optimistic reads or pessimistic reads. In one embodiment, a pessimistic writes is when an exclusive lock is acquired before writing a memory location. In one embodiment, an optimistic read is performed by validating a read on a transaction commit by using version numbers associated with a memory location. In one embodiment, a pessimistic read is performed by acquiring a shared lock before reading a memory location.

In one embodiment, a transaction using pessimistic writes and optimistic reads is an optimistic transaction, whereas a transaction using both pessimistic reads and pessimistic writes is a pessimistic transaction. In one embodiment, other read/write mechanisms of a transactional memory system (such as, write-buffering) are adaptable for use in conjunction with an embodiment of the invention.

In one embodiment, a transactional memory system uses synchronization constructs, such as, for example, an atomic block. In one embodiment, the execution of an atomic block occurs atomically and is isolated with respect to other atomic blocks. In one embodiment, the semantics of atomic blocks is based on Hierarchical Global Lock Atomicity (HGLA). In one embodiment, an atomic block is implemented using a transaction or a mutual exclusion lock. In one embodiment, outermost atomic regions are protected by using a transaction.

In one embodiment, a condition/situation in which a child thread does not create other nested transactions (or atomic blocks) is referred to herein as shallow nesting. A condition/situation in which a child thread creates other nested transactions (or atomic blocks) is referred to herein as deep nesting. In one embodiment, a child thread that further spawns other child threads is itself a parent thread.

It will be appreciated by those skilled in the art that multi-level transactional nested parallelism is possible, although to avoid obscuring embodiments of the invention, most of the examples are described herein with respect to single level nested parallelism.

In one embodiment, to support transactional nested parallelism, several features are required. The features include but not limited to: a) maintenance and processing of transactional logs; b) aborting a transaction; c) quiescence algorithm for optimistic transactions; d) concurrency control for optimistic transactions; and e) concurrency control for pessimistic transactions. The features will be described in further detail below with additional references to the remaining figures

### Maintenance and Processing of Transactional Logs

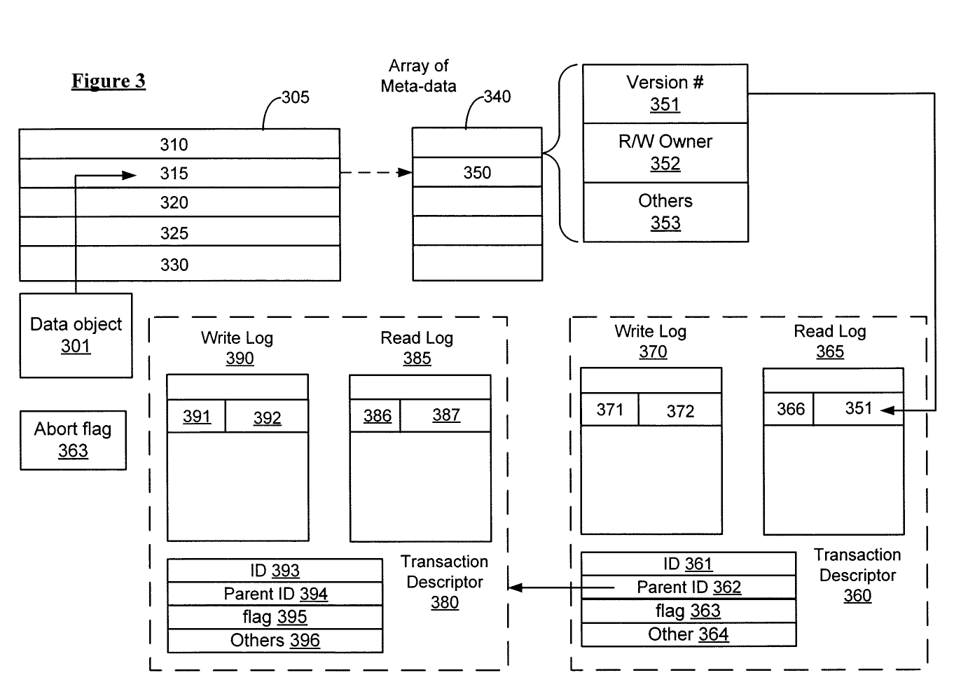

FIG. 3 shows a block diagram of an embodiment of a transactional memory system. Referring to FIG. 3, in one embodiment, data object 301 contains data having any granularity, such as a bit, a word, a line of memory, a cache line, a table, a hash table, or any other known data structure or object. For example, a data structure (defined in a program) is an example of data object 301. It will be appreciated by those skilled in the art that data object 301 may be represented and stored in memory 305 in many ways according to design memory architectures.

In one embodiment, transactional memory 305 includes any memory to store elements associated with transactions. In one embodiment, transactional memory 305 comprises plurality of lines 310, 315, 320, 325, and 330. In one embodiment, memory 305 is a cache memory.

In one embodiment, descriptor 360 is associated with a child thread and descriptor 380 is associated with a parent transaction of the child thread. Descriptor 360 includes read log 365, write log 370 (or write space), ID 361, parent ID 362, flag 363, and other data 364. Descriptor 380 includes read log 385, write log 390, ID 393, parent ID 394, flag 395, and other data 396.

In one embodiment, each data object is associated with a meta-data location, such as a transaction record, in array of meta-data 340. In one embodiment, cache line 315 (or the address thereof) is associated with meta-data location 350 in array 340 using a hash function. In one embodiment, the hash function is used to associate meta-data location 350 with cache line 315 and data object 301.

In one embodiment, data object 301 is the same size of, smaller than (multiple elements per line of cache), or larger than (one element per multiple lines of cache) cache line 315. In one embodiment, meta-data location 350 is associated with data object 301, cache line 315, or both in any manner.

In one embodiment, meta-data location 350 indicates whether data object 301 is locked or available. In one embodiment, when data object 301 is unlocked or is available, meta-data location 350 stores a first value. As an example, the first value is to represent version number 351. In one embodiment, version number 351 is updated, such as incremented, upon a write to data object 301 to track versions of data object 301.

In one embodiment, if data object 301 is locked, meta-data location 350 includes a second value to represent a locked state, such as read/write lock 352. In one embodiment, read/write lock 352 is an indication to the execution thread that owns the lock.

In one embodiment, a transaction lock, such as a read/write lock 352, is a write exclusive lock forbidding reads and writes from remote resources, i.e., resources that do not own the lock. In one embodiment, meta-data 350 or a portion thereof, includes a reference, such as a pointer to transaction descriptor 360.

In one embodiment, when a transaction reads from data object 301(or cache line 315), the read is recorded in read log 365. In one embodiment, recording a read includes storing version number 351 and address 366 associated with data object 301 in read log 365. In one embodiment, read log 365 is included in transaction descriptor 360.

In one embodiment, transaction descriptor 360 includes write log 370, as well as other information associated with a transaction, such as transaction identifier (ID) 361, parent ID 362, and other transaction information. In one embodiment, write log 370 and read log 365 are not required to be included in transaction descriptor 360. For example, write log 370 is separately included in a different memory space from read log 365, transaction descriptor 360, or both.

In one embodiment, when a transaction writes to address 315 associated with data object 201, the write is recorded as a tentative update. In addition, the value in meta-data location 350 is updated to a lock value, such as two, to represent data object 301 is locked by the transaction.

In one embodiment, the lock value is updated by using an atomic operation, such as a read, modify, and write (RMW) instruction. Examples of RMW instructions include Bit-test and Set, Compare and Swap, and Add.

In one embodiment, the write updates cache line 315 with a new value, and an old value is stored in location 372 in write log 370. In one embodiment, upon committing the transaction, the old value in write log 370 is discarded. In one embodiment, upon aborting a transaction, the old value is restored to cache line 315, (i.e., rolled-back operation).

In one embodiment, write log 370 is a buffer that stores a new value to be written to data object 301. In response to a commit, the new value is written to the corresponding location, whereas in response to an abort, the new value in write log 370 is discarded.

In one embodiment, write log 370 includes a write log, a group of check pointing registers, and a storage space to checkpoint values to be updated during a transaction.

In one embodiment, when a transaction commits, the transaction releases lock to data object 301 by restore meta-data location 350 to a value representing an unlocked state. In one embodiment, version 351 is used to indicate the lock state of data object 301. In one embodiment, a transaction validates its reads from data object 301 by comparing the value of the recorded version in the read log of the transaction to the current version 351.

In one embodiment, descriptor 360 is associated with a child thread and descriptor 380 is associated with a parent transaction of the child thread. In one embodiment, parent ID 362 in descriptor 360 stores an indication to descriptor 380 because descriptor 380 is associated with the parent transaction. In one embodiment, parent ID 394 stores an indication (e.g., a null value) to indicate that descriptor 380 is associated with a parent transaction which is not a child of any other transaction.

In one embodiment, write log 390, read log 385, ID 393, flag 395, other data 396, memory locations 391-392, memory locations 386-387 of descriptor 380 are used in a similar manner as described above with respect to descriptor 360.

In one embodiment, transactional system is associated with data such as, for example, a write log (for pessimistic writes), a read log (for pessimistic reads or version number validation), and an undo log (for rollback operations).

If multiple concurrent threads work on behalf of a transaction, sharing the logs among the multiple threads is inefficient. Even if the child threads of a same group operate over disjoint data sets, logs might still be accessed by multiple child threads concurrently. As a result, every log access has to be atomic (e.g., using a CAS operation) and incurs additional runtime cost.

In one embodiment, each team member (a thread) is associated with private logs including a write log, a read log, and an undo log (not shown). The private logs are dedicated to a thread for keeping records of reads and writes of the thread.

In one embodiment, when a group of child threads join, the logs of a child thread are merged or combined with the logs of a parent transaction. In one embodiment, when the execution of a child thread completes, the logs associated with the child thread is merged with the logs associated with the parent transaction. For example, in one embodiment, read log 365 is merged with read log 385, whereas write log 370 is merged with write log 390.

In one embodiment, if child threads do not share data among each other, no dependencies between multiple different threads exist and therefore data isolation is not an issue. In one embodiment, if a data object is accessed by two or more threads in a shallow nesting situation, such accesses are a result of an execution of a racy program. In one embodiment, results of execution of a racy program are not deterministic. In one embodiment, if a data object is accessed by two or more threads in a deep nesting situation, the nested transactions ensure data isolation with respect to the shared data object is enforced.

In one embodiment, private logs of a child thread are merged with logs of a parent transaction by a copying process. For example, read log 365 is merged with read log 385 by copying/appending contents of read log 365 into read log 385. In one embodiment, copying the entries of read logs into a single read log makes the read log easier to maintain. In one embodiment, a read log of a child thread (spawned at several levels below a parent transaction) is copied repeatedly until the read log is eventually propagated to the read log of the parent transaction. In one embodiment, similar operations are performed for merging other logs (e.g., write log, undo log) from a child thread with logs from a parent transaction.

In one embodiment, private logs of a child thread are merged with logs of a parent transaction by a concatenating the private logs. For example, read log 365 is merged with read log 385 by using a reference link or a pointer. In one embodiment, read log 385 stores a reference link to read log 365. Entries of read log 365 are not copied to read log 385. In one embodiment, processing and maintenance of such read log is more complicated because the read log of a parent transaction includes multiple logs (multiple levels of indirection). In one embodiment, similar operations are performed for merging other logs (e.g., write log, undo log) from a child thread with logs from a parent transaction.

In one embodiment, logs are combined by copying, concatenating, or the combination of both. In one embodiment, logs are merged by copying if the number of entries in a private log is less a predetermined value. Otherwise, logs are merged by concatenating.

### Transaction Abort

Referring to FIG. 3, in one embodiment, if only one thread exists, a transaction captures its execution states (registers, values of local variables, etc.) as a check point. In one embodiment, the information in a check point is restored (rollback operation) if a transaction aborts (e.g., via a long jump, execution stack unwinding, etc.).

In one embodiment, for a transactional memory system that supports transactional nested parallelism, any thread from a same group of threads is able to trigger an abort.

In one embodiment, a child thread writes a specific value to abort flag 363 when it is going to abort. In one embodiment, abort flag 363 is readable by all threads in a same group including the parent transaction. If any thread in the same group aborts, all the threads of the same group are also going to abort. In one embodiment, the main transaction aborts if any thread created in response to the main transaction (including all the descendents thereof) aborts.

In one embodiment, checkpoint information for each child tread is saved separately. If any team member triggers an abort, abort flag 363 is set visible to all threads in the team. In one embodiment, abort flag 363 is stored in descriptor 380 or in descriptor associated with a parent transaction.

In one embodiment, a team member examines abort flag 363 periodically. In one embodiment, a team member examines abort flag 363 during some “poll points” inserted by a compiler. In one embodiment, a team member examines abort flag 363 during runtime at a loop-back edge. A child thread restores the checkpoint and proceeds directly to the join point if abort flag 363 is set.

In one embodiment, a team member examines abort flag 363 when the execution has completed and the child thread is ready to join.

In one embodiment, if a team member determines that abort flag 363 is set, a team member follows the same procedure as the thread that triggers the abort. In one embodiment, the roll-back operation of a team member is performed by the team member itself after the team member detects that abort flag 363 is set. In one embodiment, roll back operations are performed by a parent transaction that only examines abort flag 363 after all child threads reach the join point.

### Quiescence Validation

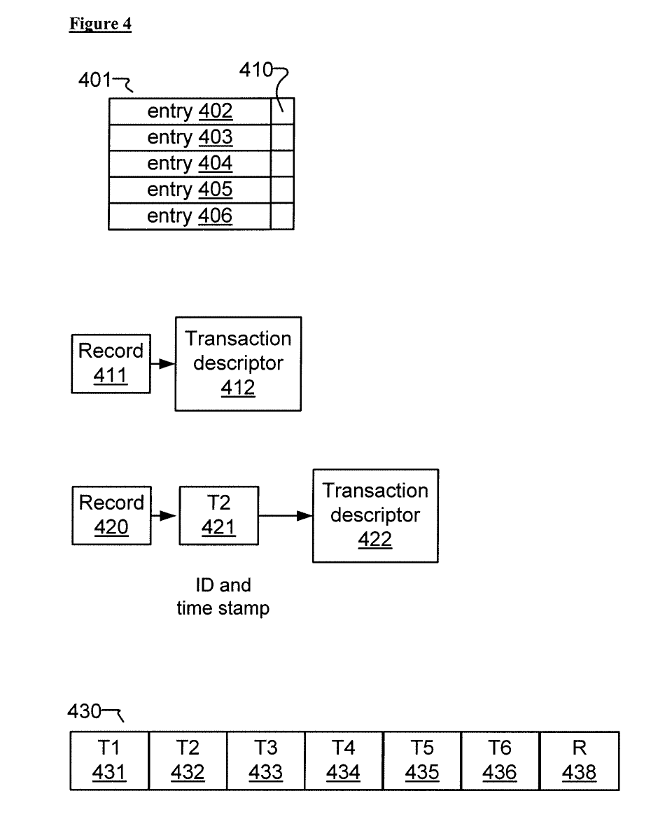

FIG. 4 shows a block diagram of an embodiment of a quiescence table and meta-data associated with a shared data object. In one embodiment, referring to FIG. 4, quiescence table 401 includes multiple entries 402-406, with each entry associated with a disable bit.

In one embodiment, a quiescence algorithm verifies that a transaction commits only if the execution states of other transactions are valid with respect to the execution of the transaction (e.g., write operations performed by the transaction).

In one embodiment, quiescence table 401 is a global data structure (e.g., array, list, etc.) that stores time stamps for every transaction in the system. A timestamp in the quiescence table (e.g., entry 402 associated with a transaction) is updated periodically based on a global timestamp. In one embodiment, a global timestamp is a counter value incremented when a transaction becomes committed.

In one embodiment, entry 402 is updated periodically to indicate that the transaction is valid with respect to all other transactions at a given value of the global timestamp.

In one embodiment, for a shallow nesting condition, each child thread is associated with an entry respectively in quiescence table 401. In one embodiment, the entry of a parent transaction is disabled temporarily (by setting disable bit 410) and is considered to be valid. In one embodiment, after all the child threads of the parent transaction are complete and are ready to rejoin, the entry of the parent transaction is enabled again (by clearing disable bit 410). In one embodiment, the entry for the parent transaction is updated to the timestamp of a child thread which has been validated least recently. In one embodiment, the entry for the parent transaction is updated with a lowest timestamp value associated with the child threads when the entry is enabled again.

In one embodiment, a hierarchical quiescence algorithm is used if a deep nesting condition exists. In one embodiment, a quiescence table is created for an atomic block nesting level. Child threads that are spawned directly from a same parent transaction/thread are in a same nesting level. These child threads share a quiescence table and validation is performed with respect to each others within the same nesting level. In one embodiment, quiescence is required among child threads at the same level of atomic block nesting and sharing the same parent. In one embodiment, for a deep nesting condition, child threads in different nesting levels are not required to validate quiescence against each others. In one embodiment, for a deep nesting condition, the executions of the child threads are isolated with respect to each others because transactions are used to protect the shared data.

### Optimistic Data Concurrency

In one embodiment, a resource or a data object is associated with meta-data (a resource record). Referring to FIG. 4, in one embodiment, meta-data includes a write lock (e.g., record 411) if a transactional memory system performs an optimistic transaction. In one embodiment, record 411 is used to determine whether a memory location is locked or unlocked.

In one embodiment, communication among a parent transaction and child transactions is used so that child threads are able to access workload of the parent transaction. For example, a memory location modified by the parent thread (exclusively owned) is also made accessible to its child transactions.

In one embodiment, a child transaction is allowed to read a memory location locked by a corresponding parent transaction. In one embodiment, a child acquires its own write lock for writing a location so that data is synchronized with respect to other child transactions originating from the same parent. In one embodiment, concurrent writes to a same location from multiple team members that started their own atomic regions are prohibited.

In one embodiment, a child transaction overrides write lock of a parent transaction. In one embodiment, a child transaction returns ownership of the lock to the parent transaction when the child transaction commits or aborts.

In one embodiment, record 411 stores an indication (e.g., a pointer) to descriptor 412 that is associated with a parent transaction. In one embodiment, descriptor 412 stores information about the current lock owner of a shared data object.

In one embodiment, a child transaction overrides write lock of the parent transaction. Record 420 is updated such that a level of indirection is created between record 420 and descriptor 422. In one embodiment, a small data structure including a timestamp and a thread ID of a child is inserted in between record 420 and descriptor 422.

In one embodiment, the write locks are released by a parent transaction. In one embodiment, multiple levels of indirections are cleaned up when a lock is released according to a lock-release procedure. In one embodiment, some existing data structures (e.g., entries in transactional logs) are reused or extended to avoid having to create the data structure every time the data structure is required.

In one embodiment, if a child transaction reads a memory location which was already written by a parent transaction, the child transaction acquires an exclusive lock on the memory location. In one embodiment, only one child transaction is allowed to access a memory location locked by the parent but any other child transaction is not allowed to read or write the memory location.

In one embodiment, a separate data structure is used to store a timestamp taken at the point when a child transaction reads the memory location that has been written by its parent transaction. In one embodiment, the timestamp is updated each time a child transaction commits an update to the same location.

In one embodiment, ownership of the lock is returned to a parent thread only if the parent thread originally owned the lock. In one embodiment, a parent thread has enough information to release a write lock when a child transaction commits because a private write log of the child thread is merged with the write log of the parent transaction after a child transaction commits. In one embodiment, the private logs of a child transaction that aborts are saved or merged similarly as a child transaction that commits.

In one embodiment, if a transaction executed by a child thread writes a memory location locked by a parent transaction, a structure is inserted (e.g., 421) indicating that this transaction (T2) is the current owner right before descriptor 422 representing the original owner (parent transaction).

In one embodiment, one or more structures are inserted for multi-level nested parallelism. For example, an indirection structure is inserted for each transfer of a lock from a parent to a child transaction. In one embodiment, the structures form a sequence of write lock owners.

### Pessimistic Data Concurrency

In one embodiment, a resource or a data object is associated with meta-data (a resource record). Referring to FIG. 4, in one embodiment, meta-data includes record 430 if a transactional memory system performs a pessimistic transaction. In one embodiment, record 430 is used to determine whether a memory location is locked or unlocked. In one embodiment, record 430 encodes information with respect to a read lock and a write lock acquired for a given memory location.

In one embodiment, record 430 shows an encoding for pessimistic transactions. In one embodiment, T1 431 is a bit representing whether T1 (thread 1 or transaction 1) is a lock owner with respect to a data object. In a similar manner, T2-T6 (i.e., 432-436) each represents the lock state with respect to another child thread or another transaction respectively. In one embodiment, a lock owner is a transaction (or a child thread) that acquires exclusive access to a data object.

In one embodiment, R 438 is a read lock bit indicating whether a data object is locked for a write or for a read. In one embodiment, R 438 is set to ‘1’ if a data object is locked for a read, and R 438 is set to ‘0’ if the data object is locked for a write.

In one embodiment, a child thread is able to acquire a read lock or a write lock associated with a data object that is already locked by one of the ancestors of the child thread.

In one embodiment, for example, parent transaction T1 owns a read lock on a data object. T1 431 is set to ‘1’ and R 438 is set to ‘1’. If a team member (T2) later acquires the read lock from T1, T2 432 is set to ‘1’ indicating that T2 holds a lock and R 438 remains as ‘1’ indicating the data object is still locked for a read.

In one embodiment, for example, parent transaction T1 owns a read lock on a data object. T1 431 is set to ‘1’ and R 438 is set to ‘1’. If a team member (T2) acquires a write lock on the data object, T2 432 is set to ‘1’ indicating that T2 also holds a lock and R 438 is set to ‘0’ indicating that the data object is locked for a write.

In one embodiment, for example, parent transaction T1 owns a write lock on a data object. T1 431 is set to ‘1’ and R 438 is set to ‘0’. If a team member (T2) acquires a read lock on the data object, T2 432 is set to ‘1’ indicating that T2 holds a lock on the data object while R 438 remains ‘0’ indicating that the data object is locked for a write by the parent transaction Ti.

In one embodiment, for example, parent transaction T1 owns a write lock on a data object. T1 431 is set to ‘1’ and R 438 is set to ‘0’. If a team member (T2) acquires a write lock on the data object, T2 432 is set to ‘1’ indicating that T2 holds a lock on the data object while R 438 remains ‘0’ indicating that the data object is locked for a write by the parent transaction T1 and thread T2.

In one embodiment, each transaction that accesses a data object is associated with a lock owner bit respectively in record 430. In one embodiment, a child thread (or a transaction) acquires a write lock on a data object is allowed only if all lock owner bits are associated with the ancestors of the thread, regardless of the value of R 438.

In one embodiment, a sequence of write lock owners with respect to a data object are recorded as described above with respect to optimistic transactions. In one embodiment, if a child thread holds a lock on a data object and triggers an abort, the previous write lock owner (a parent transaction) of the data object relinquishes the write lock from the child thread.

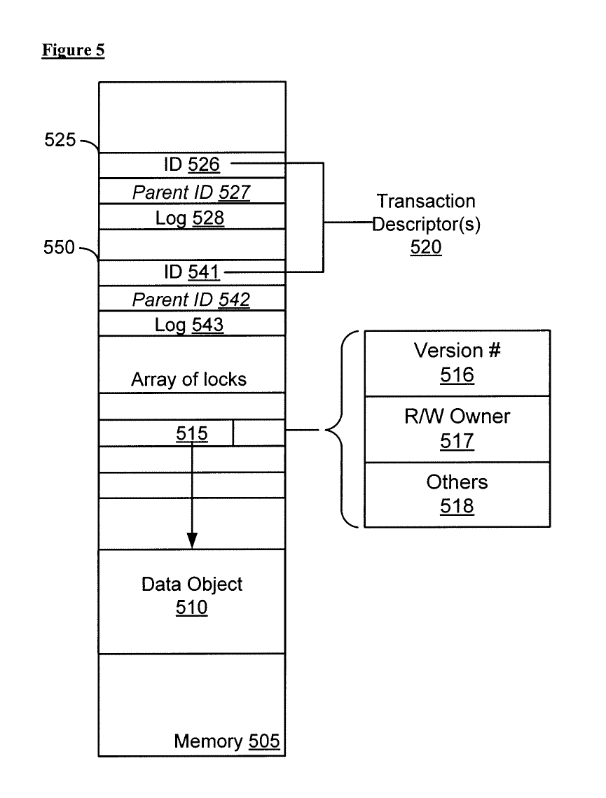

FIG. 5 shows an embodiment of a memory device to store a transactional descriptor, an array of meta-data, and a data object. In one embodiment, a multi-resource (e.g., multi-core or multi-threaded) processor executes transactions concurrently. In one embodiment, multiple transaction descriptors or multiple transaction descriptor entries are stored in memory 505.

Referring to FIG. 5, in one embodiment, transaction descriptor 520 includes entries 525 and 550. Entry 525 includes transaction ID 526 to store a transaction ID, parent ID 527 to store a transaction ID of the parent transaction, and log space 528 to include a read log, a write log, an undo log, or any combinations thereof. In a similar manner, Entry 550 includes transaction ID 541, parent ID 542, and log space 543.

In one embodiment, other information, such as, for example, a resource structure, a thread structure, a core structure, of a processor is stored in transaction descriptor 520.

In one embodiment, memory 505 also stores data object 510. As mentioned above, data object can be any granularity of data, such as a bit, a word, a line of memory, a cache line, a table, a hash table, or any other known data structure or object.

In one embodiment, meta-data 515 is meta-data associated with data object 510. In one embodiment, meta-data 515 include version number 516, read/write locks 517, and other information 518. The data fields stores information as described above with respect to FIG. 2.

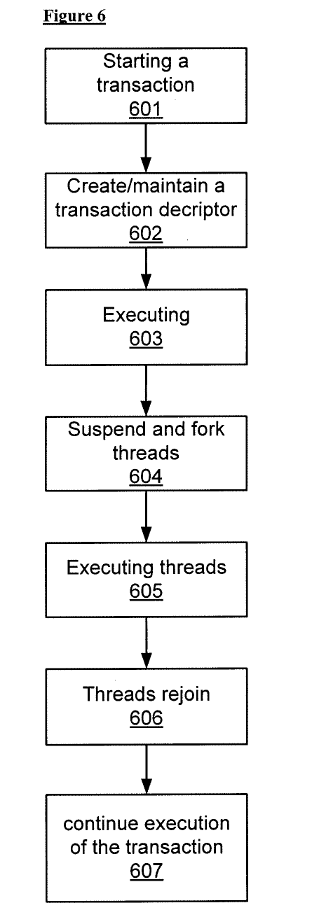

FIG. 6 is a flow diagram for an embodiment of a process to implement transactional nested parallelism. The process is performed by processing logic that may comprise hardware (circuitry, dedicated logic, etc.), software (such as one that is run on a general purpose computer system or a dedicated machine), or a combination of both. In one embodiment, the process is performed by processor 100 with respect to FIG. 1.

Referring to FIG. 6, in one embodiment, the process begins by processing logic starts a parent transaction (process block 601). Processing logic creates and maintains a transaction descriptor associated with the parent transaction (process block 602). In one embodiment, processing logic executes in response to instructions in the parent transaction (process block 603).

In one embodiment, processing logic suspends executing the parent transaction and spawns a number of child threads at a fork point (process block 604). In one embodiment, the child threads are spawned in response to an execution of the parent transaction. In one embodiment, a child thread is also referred to as a team member. In one embodiment, the child threads execute some computation on behalf of the parent transaction. In one embodiment, the child threads execute concurrently. In one embodiment, the child threads execute in parallel on multiple computing resources.

In one embodiment, processing core performs executions for the child threads (process block 605). In one embodiment, the child threads rejoin when their executions are completed (process block 606). In one embodiment, logs associated with each child thread are merged with logs associated with the parent transaction.

In one embodiment, processing logic resumes executing the parent transaction after the child threads rejoin (process block 607).

In one embodiment, processing logic performs maintenance and processing of transactional logs, read/write validation, quiescence validation, aborting a transaction, aborting a group of child threads, and other operations.

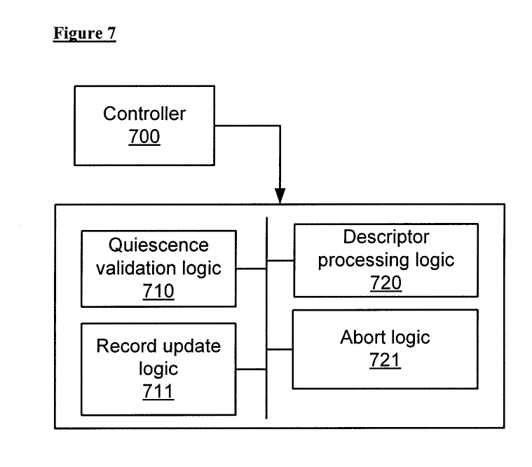

FIG. 7 is a block diagram of one embodiment of a transactional memory system. Referring to FIG. 7, in one embodiment, a transactional memory system comprises controller 700, quiescence validation logic 710, record update logic 711, descriptor processing logic 720, and abort logic 721.

In one embodiment, controller 700 manages overall processing of a transactional memory system. In one embodiment, controller 700 manages overall execution of a transaction including a group of child threads spawned by the transaction. In one embodiment, a transaction memory system also includes memory to stores codes, data, data objects, and meta-data used in the transactional memory system.

In one embodiment, quiescence validation logic 710 performs quiescence validation operations for all pending transactions and the child threads thereof.

In one embodiment, record update logic 711 manages and maintain meta-data associated with a data object. In one embodiment, record update logic 711 determines whether a data object is locked or not. In one embodiment, record update logic 711 determines owners and the type of a lock on the data object.

In one embodiment, descriptor processing logic 720 manages and maintains descriptors associated with a transaction or a child thread thereof. In one embodiment, descriptor processing logic 720 determines a parent ID of a child thread, resources locked (or owned) by a transaction, and updates to transactional logs associated with a transaction. In one embodiment, descriptor processing logic also performs read validation when a transaction commits.

In one embodiment, abort logic 721 manages the process when a transaction aborts or a child thread aborts. In one embodiment, abort logic 721 determines whether any of child threads triggers an abort. In one embodiment, abort logic 721 sets an abort indication accessible to all threads spawned directly or indirectly from a same parent transaction. In one embodiment, abort logic 721 preserves logs of a child thread that aborts.

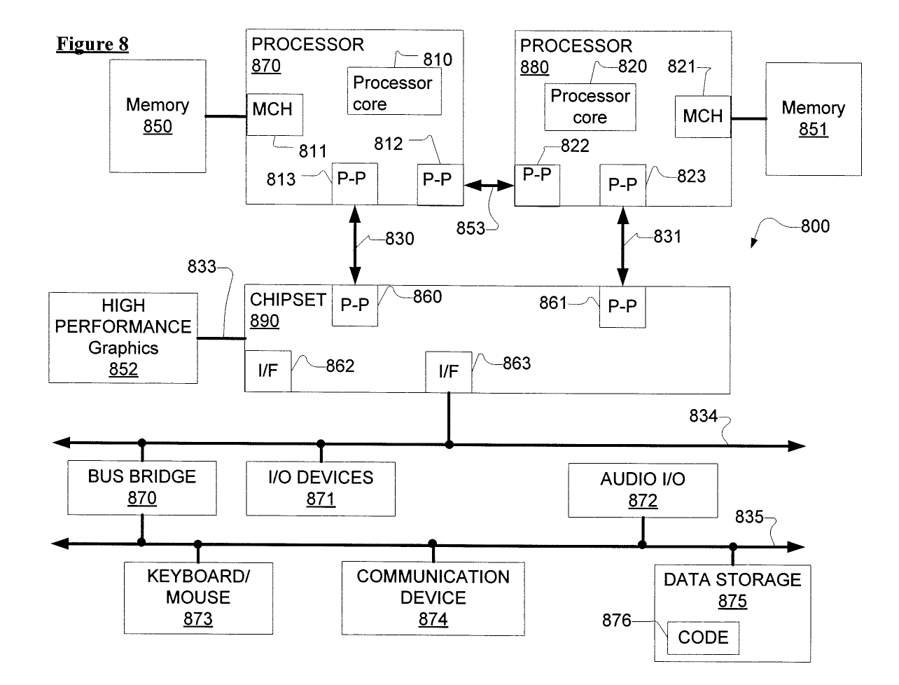

FIG. 8 illustrates a point-to-point computer system in conjunction with one embodiment of the invention.

FIG. 8, for example, illustrates a computer system that is arranged in a point-to-point (PtP) configuration. In particular, FIG. 8 shows a system where processors, memory, and input/output devices are interconnected by a number of point-to-point interfaces.

The system of FIG. 8 may also include several processors, of which only two, processors 870, 880 are shown for clarity. Processors 870, 880 may each include a local memory controller hub (MCH) 811, 821 to connect with memory 850, 851. Processors 870, 880 may exchange data via a point-to-point (PtP) interface 853 using PtP interface circuits 812, 822. Processors 870, 880 may each exchange data with a chipset 890 via individual PtP interfaces 830, 831 using point to point interface circuits 813, 823, 860, 861. Chipset 890 may also exchange data with a high-performance graphics circuit 852 via a high-performance graphics interface 862. Embodiments of the invention may be coupled to computer bus (834 or 835), or within chipset 890, or coupled to data storage 875, or coupled to memory 850 of FIG. 8.

Other embodiments of the invention, however, may exist in other circuits, logic units, or devices within the system of FIG. 8. Furthermore, in other embodiments of the invention may be distributed throughout several circuits, logic units, or devices illustrated in FIG. 8.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
creating, in response to executing a first transaction, a first group of one or more concurrent threads including a first thread, wherein the first thread is associated with first data comprising an indication of an association between the first thread and the first transaction.

2. The method of claim 1, further comprising:
suspending the first transaction before executing the first group of threads; and
resuming the first transaction after the first group of threads rejoins.

3. The method of claim 1, wherein the first data further comprises a first write log and a first read log, wherein the first transaction is associated with second data comprising a second write log and a second read log, further comprising:
merging the first write log with the second write log before resuming the first transaction after the first group of threads completes; and
merging the first read log with the second read log.

4. The method of claim 1, further comprising creating, in response to executing the first thread, a second group of nested threads, a second nested transaction, or both.

5. The method of claim 1, further comprising setting an abort flag accessible by the first group of threads and the first transaction if the first thread is going to abort.

6. The method of claim 1, further comprising acquiring, by the first thread, a lock of a data object which is exclusively locked by the first transaction.

7. The method of claim 1, further comprising maintaining meta-data associated with a shared data object, wherein the meta-data comprises an indication of two or more lock owners.

8. The method of claim 1, further comprising validating the first thread by validating a read log of the first thread and a read log of the first transaction.

9. The method of claim 1, further comprising performing quiescence validation for a second group of nested threads created in response to executing the first thread.

10. The method of claim 1, wherein the first data is a transaction descriptor.

11. A system comprising:
a processor to create, in response to executing a first transaction, first group of one or more concurrent threads including a first thread; and
memory to store first data associated with the first thread, wherein the first data comprises an indication of an association between the first thread and the first transaction.

12. The system of claim 11, the processor is operable to suspend the first transaction before begin execution of the first group of threads and to resume the first transaction after the first group of threads rejoins.

13. The system of claim 11, wherein the processor, in response to execution of the first thread, creates second group of nested threads, a second nested transaction, or both.

14. The system of claim 11, wherein the first thread acquires a lock of a data object which is exclusively locked by the first transaction.

15. The system of claim 11, wherein the processor comprises:
record update logic;
transaction descriptor logic; and
quiescence validation logic.

16. An article of manufacture comprising a computer readable storage medium including data storing instructions thereon that, when accessed by a machine, cause the machine to perform a method comprising:
creating, in response to executing a first transaction, a first group of one or more concurrent threads including a first thread, wherein the first thread is associated with first data comprising an indication of an association between the first thread and the first transaction.

17. The article of claim 16, wherein the method further comprises:
suspending the first transaction before executing the first group of threads; and
resuming the first transaction after the first group of threads rejoins.

18. The article of claim 16, wherein the first data further comprises a first write log and a first read log, wherein the first transaction is associated with second data comprising a second write log and a second read log, wherein the method further comprises:
merging the first write log with the second write log before resuming the first transaction after the first group of threads completes; and
merging the first read log with the second read log.

19. The article of claim 16, wherein the method further comprises creating, in response to executing the first thread, a second group of nested threads, a second nested transaction, or both.

20. The article of claim 16, wherein the method further comprises setting an abort flag accessible by the first group of threads and the first transaction if the first thread is going to abort.

21. The article of claim 16, wherein the method further comprises acquiring, by the first thread, a lock of a data object which is exclusively locked by the first transaction.

22. The article of claim 16, wherein the method further comprises maintaining meta-data associated with a shared data object, wherein the meta-data comprises an indication of two or more lock owners.

23. The article of claim 16, wherein the method further comprises validating the first thread by validating a read log of the first thread and a read log of the first transaction.

24. The article of claim 16, wherein the method further comprises performing quiescence validation for a second group of nested threads created in response to executing the first thread.
